(19) United States
(12) Patent Application Publication
(10) Pub. No.: US 2026/0368030 A1
(43) Pub. Date: Nov. 19, 2026

(54) Apparatus for AIOps-Enabled Incident Isolation and Recovery Automation

(71) Applicants: Samiuddin Mohammed, Irving, TX (US); Venkata Kalyan Polamarasetty, Prosper, TX (US)

(72) Inventors: Samiuddin Mohammed, Irving, TX (US); Venkata Kalyan Polamarasetty, Prosper, TX (US)

(21) Appl. No.: 19/727,006

(22) Filed: Jul. 1, 2026

(51) Int. Cl. G06F 11/07

(52) U.S. Cl. CPC G06F 11/0793; G06F 11/0709; G06F 11/079

(57) ABSTRACT

An apparatus, method, and non-transitory computer-readable medium are disclosed for autonomous incident lifecycle management within complex, distributed computing environments. The architecture comprises a high-throughput data ingestion engine configured to aggregate and normalize heterogeneous telemetry data, which is subsequently analyzed by a machine learning processing unit to establish dynamic behavioral baselines and detect operational anomalies. A topology-aware engine maintains a real-time graph of infrastructure interdependencies, enabling a diagnostic module to perform automated root cause analysis (RCA) by isolating the primary trigger of system failures. Upon root cause isolation, an automated remediation controller executes context-aware recovery workflows—such as service restarts, traffic rerouting, or resource scaling—to restore optimal system performance without human intervention. A feedback loop database and reinforcement learning module continuously refine the system's diagnostic and remediation models based on post-remediation validation outcomes, ensuring increased precision, reduced Mean Time to Repair (MTTR), and enhanced operational resilience in cloud-native architectures.

### FIELD OF INVENTION

The present invention relates generally to the field of information technology (IT) operations and, more particularly, to an apparatus and method for utilizing artificial intelligence for IT operations (AIOps) to automatically detect, isolate, and remediate technical incidents within complex, distributed enterprise network environments.

### BACKGROUND

Modern enterprise information technology (IT) ecosystems have transitioned from static, localized data centers to highly dynamic, distributed, and multi-layered architectures. These contemporary operational environments are characterized by extreme structural and behavioral complexity, often orchestrating hybrid-cloud infrastructures, cloud-native deployments, multi-region setups, and dense microservices meshes. Applications are no longer monolithic; instead, they are decoupled into thousands of discrete, ephemeral containers and serverless functions that interact asynchronously across shifting network topologies. This architectural evolution introduces significant volatility, as virtual resources are constantly provisioned, auto-scaled, and decommissioned based on real-time traffic fluctuations. Consequently, the operational boundaries of these environments are continuously fluid, rendering traditional static infrastructural mapping and conventional management paradigms wholly inadequate for maintaining systemic stability.

The exponential expansion and inherent fluidity of these modern IT environments generate an unprecedented, multi-dimensional deluge of operational telemetry data. This heterogeneous data influx, commonly categorized under the paradigm of “Big Data,” encompasses structured, semi-structured, and unstructured data streams generated continuously at high velocity. Specifically, this telemetry includes high-frequency performance metrics (such as CPU, memory, network I/O, and disk utilization), unstructured machine-generated log files from disparate operating systems and applications, event logs from orchestration platforms, and deep distributed tracing context across complex application programming interface (API) call paths. The sheer volume and high cardinality of this real-time data exhaust create a severe computational and cognitive bottleneck, making it mathematically and operationally impossible to store, process, and interpret these streams holistically using legacy computing systems.

Traditional IT monitoring systems and monitoring tools rely heavily on static, hardcoded, threshold-based alerting mechanisms to identify system abnormalities. These legacy frameworks require human operators to manually configure deterministic rules, such as generating an alert if a specific server's central processing unit (CPU) utilization exceeds a fixed percentage for a predefined duration. However, such deterministic models fail fundamentally to account for the dynamic, highly variable, and non-linear behavior of cloud-native and microservice-oriented architectures. Systems frequently exhibit benign performance spikes during legitimate cyclic workloads or distributed batch processing operations, which static systems misclassify as critical errors. Conversely, subtle, creeping degradation patterns across distributed components often pass undetected because no single metric breaches its isolated, static threshold, thereby exposing the enterprise to unmitigated systemic risks.

A direct consequence of relying on these rigid, static threshold frameworks within high-volume data environments is the pervasive generation of redundant, correlated, and irrelevant alerts, a phenomenon widely documented as “alert fatigue.” When a single foundational component undergoes degradation within a tightly coupled distributed application, it triggers a cascading domino effect, causing hundreds of downstream services to simultaneously emit independent, high-priority alarms. As a result, IT operations (ITOps) and Site Reliability Engineering (SRE) teams are routinely inundated with thousands of disjointed, false-positive or duplicate notifications daily. This overwhelming cognitive overload severely dulls human responsiveness, causing critical, high-fidelity indicators of catastrophic infrastructure failures to become buried within operational noise and inadvertently ignored by fatigued human operators.

In the event of a severe operational incident, manual troubleshooting inside these modern distributed systems is prohibitively slow, fragmented, and inefficient. Because operational data is traditionally siloed across disparate monitoring platforms—where logs, metrics, and traces are maintained in isolated databases with incompatible schemas—human operators must manually extract, correlate, and cross-reference information. This manual triage process typically requires logging into multiple command-line interfaces, executing ad-hoc search queries, aligning divergent timestamps across varying server time zones, and attempting to piece together a coherent timeline of the incident. Such fragmented workflows heavily depend on the tribal knowledge and subjective intuition of specialized domain experts, creating severe organizational bottlenecks when those key individuals are unavailable.

The intrinsically manual and uncoordinated nature of conventional root cause analysis (RCA) fundamentally expands the Mean Time to Repair (MTTR) a system failure. While an enterprise's system downtime persists, the delay in identifying the primary causal trigger directly impacts service availability, degrades user experience, and compromises business continuity. For modern digital enterprise platforms, even brief periods of degraded performance or outright outages translate into substantial financial losses, contractual service-level agreement (SLA) penalties, brand erosion, and customer churn. Because existing diagnostic methodologies are reactive and retrospective rather than proactive and real-time, the time gap between initial incident inception and ultimate remediation execution remains unacceptably wide.

Furthermore, accurately determining the specific structural “blast radius” of an ongoing infrastructure or application failure within a dense microservices service mesh is a task that far exceeds human cognitive capacity in real-time. In an environment where thousands of interdependent services communicate via complex, asynchronous message queues and dynamic routing protocols, a localized latency anomaly in an upstream service can manifest as a total application failure in a completely unrelated downstream user interface. Human analytical workflows are fundamentally incapable of visually mapping, tracking, and mathematically calculating the structural and behavioral dependencies of these multi-tiered failures dynamically as they unfold at millisecond scale, leading to prolonged misdiagnoses and misallocated engineering resources.

Current automated monitoring and orchestration tools lack the deep semantic and contextual awareness required to effectively differentiate between a localized, transient anomaly and a widespread, systemic service outage. Existing automation systems typically operate on localized, short-sighted algorithmic rules that execute predefined actions without assessing the broader health or architectural topology of the environment. For example, an automated script might prematurely terminate and restart an enterprise database instance upon detecting a temporary query timeout; however, if the true root cause is an underlying network routing misconfiguration or a distributed denial-of-service (DDoS) attack, such a blind restart can corrupt the database state, exacerbate network congestion, and transform a minor transient hiccup into a prolonged, catastrophic systemic outage.

There exists a persistent, highly detrimental operational disconnect between event detection systems, diagnostic isolation tools, and remediation execution frameworks. In the current state of the art, these three phases of the incident management lifecycle operate as isolated, non-communicative software silos. An application performance monitoring (APM) tool may flag an anomaly, an IT service management (ITSM) tool may log a ticket, and an automation configuration tool (such as an orchestration engine) may hold the capability to execute a recovery script. However, transferring data smoothly and securely between these systems requires manual human intervention, complex API integrations, or slow ticketing workflows, causing severe friction, data loss, contextual dilution, and prolonged operational delays during critical, time-sensitive system emergencies.

Consequently, there is an urgent, clear, and unfulfilled technical need in the art for an integrated, automated, AIOps-enabled computing apparatus and method capable of bridging this operational gap. Such an apparatus must be uniquely engineered to ingest massive streams of multi-source telemetry data in real-time, intelligently suppress alert noise, dynamically map shifting infrastructure dependencies, and algorithmically isolate true root causes. Crucially, the apparatus must possess the contextual intelligence to automatically trigger precise, adaptive, risk-mitigated recovery workflows without requiring human intervention, thereby fundamentally reducing MTTR, ensuring system high availability, and optimizing enterprise operational resilience.

### SUMMARY OF THE INVENTION

The present invention discloses an integrated, AIOps-enabled apparatus and methodology designed for high-fidelity, real-time incident lifecycle management within complex, distributed computing environments. The apparatus serves as an intelligent intermediary between heterogeneous infrastructure telemetry and automated remediation actuators, facilitating a closed-loop system that operates at machine speed to maintain service-level objectives (SLOs) without the requirement of manual operator intervention.

A primary technical objective of the present invention is to significantly decrease the Mean Time to Repair (MTTR) by replacing traditional, human-dependent reactive troubleshooting with intelligent, automated incident isolation and precision recovery. By leveraging advanced machine learning algorithms, the apparatus distinguishes between transient system noise and genuine operational failures, thereby reducing the operational burden on SRE and ITOps teams while ensuring rapid restoration of mission-critical services.

The apparatus comprises a high-throughput data ingestion engine configured to aggregate, normalize, and unify multi-source telemetry data. This engine is designed to ingest high-velocity data streams from a diverse array of sources, including, but not limited to, system logs, environmental metrics, distributed tracing spans, and infrastructure event feeds. By normalizing these disparate formats into a common schema, the ingestion engine enables the downstream processing units to perform cross-domain correlation that is otherwise unattainable in siloed monitoring architectures.

At the core of the apparatus resides an intelligent Machine Learning (ML) processing unit. This unit is configured to perform multi-variate analysis on the ingested telemetry data to identify anomalous patterns in real-time. By utilizing unsupervised learning models—such as clustering, neural networks, or temporal pattern recognition—the ML unit continuously establishes dynamic baselines for normal system behavior, allowing it to detect deviations that signify impending or active system failures before they manifest as critical service outages.

The present invention further incorporates a sophisticated topology-aware engine that maintains an active, real-time graph representation of the computing environment. This engine dynamically maps and updates the interdependencies between physical infrastructure, virtualized containers, microservices, and network segments. By maintaining this structural context, the apparatus ensures that the AI models understand the relational hierarchy of the system, enabling it to track the propagation of a failure through the application stack.

In conjunction with the topology-aware engine, the diagnostic module is configured to perform automated root cause analysis (RCA). By analyzing the causal relationships between identified anomalies across the dependency graph, the diagnostic module isolates the specific source component—whether it be a hardware fault, a software bug, or a configuration drift—that initiated the incident, effectively peeling away “symptomatic” alerts to reveal the singular underlying cause.

Once the root cause is isolated, an automated remediation controller within the apparatus executes pre-verified, context-aware recovery workflows. These workflows are tailored to the specific nature of the identified failure. For instance, the controller may execute an automated container restart, re-provisioning of cloud instances, traffic rerouting, or automated configuration rollbacks, ensuring that the remedy is mathematically likely to resolve the underlying issue without causing secondary failures or service disruptions.

To guarantee system reliability, the apparatus implements a continuous post-remediation validation module. After the execution of a recovery workflow, this module autonomously queries the system metrics to confirm that the service state has returned to an optimal operating condition. If the validation indicates that the incident persists, the system is configured to escalate the event or trigger an alternative secondary remediation strategy, thereby ensuring a fail-safe approach to incident resolution.

The apparatus includes an adaptive feedback loop that facilitates continuous improvement. This loop stores the outcomes of every incident lifecycle—recording whether a specific remediation action successfully resolved the incident or failed. By incorporating these results back into the ML processing unit, the system iteratively refines its diagnostic and remediation models, effectively “learning” from previous incidents to become more precise and efficient over time.

Ultimately, the invention provides a highly scalable, modular architecture that effectively bridges the gap between passive observability and active automated control. By fusing deep system diagnostics with autonomous decision-making capabilities, the present invention empowers modern enterprises to maintain resilient, self-healing digital infrastructures, ultimately ensuring superior system reliability and long-term operational efficiency in the face of increasing cloud-native complexity.

### BRIEF DESCRIPTION OF THE DRAWINGS

FIG. 1 is a high-level architectural block diagram illustrating the primary functional components of the AIOps-enabled incident isolation and recovery apparatus. The diagram depicts the Data Ingestion Engine (101), which receives multi-source telemetry, coupled with the ML Processing Unit (102) that performs pattern analysis. The Topology-Aware Engine (103) maintains the dependency graph of the environment (100), while the Diagnostic Module (104) interfaces with the Automated Remediation Controller (105) to resolve incidents. All operational data and decision histories are stored within the Feedback Loop Database (106), which facilitates continuous model refinement.

FIG. 2 is a logical flow diagram representing the sequential steps of the automated incident lifecycle within the apparatus. The process initiates at Step (201) with the real-time telemetry ingestion from various network nodes, followed by Step (202) where the ML Processing Unit (102) performs multivariate correlation to detect anomalies. At Step (203), the Topology-Aware Engine (103) identifies the failure blast radius, leading to Step (204), where the Diagnostic Module (104) performs root cause isolation. Subsequently, at Step (205), the Automated Remediation Controller (105) executes the optimal recovery workflow, and finally, at Step (206), the apparatus performs post-remediation validation and updates the Feedback Loop Database (106) to finalize the cycle.

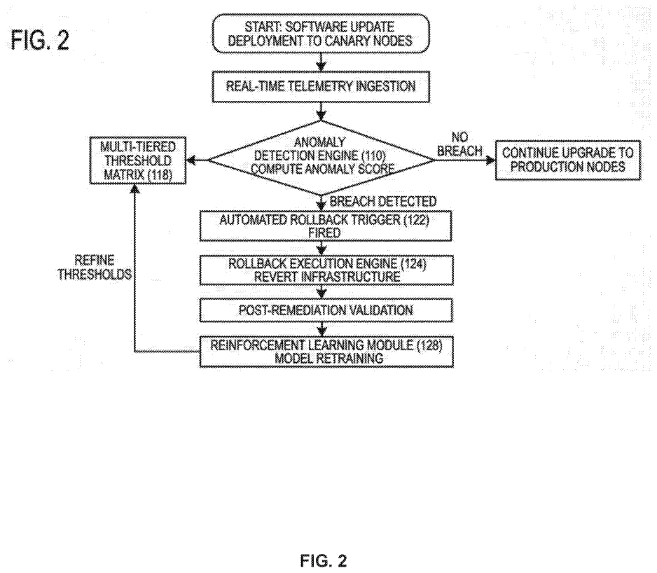

### DETAILED DESCRIPTION

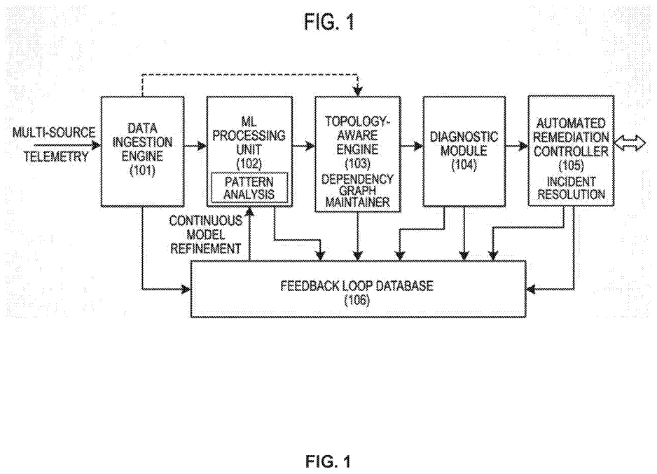

Referring to FIG. 1, the present invention discloses an AIOps-enabled apparatus for autonomous incident isolation and recovery automation within cloud-native and distributed computing environments. The apparatus is designed to continuously monitor operational conditions, detect anomalies, identify root causes, execute corrective actions, and learn from previous incidents to improve future responses. The disclosed architecture enables enterprises to reduce downtime, improve service availability, and minimize manual intervention during operational disruptions.

The apparatus comprises a Data Ingestion Engine (101) configured to receive telemetry information from a plurality of heterogeneous data sources distributed throughout the computing infrastructure. Such data sources may include application performance monitoring systems, infrastructure monitoring tools, server logs, network devices, cloud management platforms, container orchestration systems, distributed tracing frameworks, and security monitoring systems. The Data Ingestion Engine continuously captures operational events and streams the collected information for further analysis.

In one embodiment, the Data Ingestion Engine (101) performs normalization, filtering, aggregation, and enrichment operations on incoming telemetry data. Since operational information may originate from multiple vendors and monitoring platforms using different formats and protocols, the normalization process converts all incoming data into a unified schema. This standardized representation facilitates efficient downstream processing and enables consistent analytical operations across the entire infrastructure landscape.

The normalized telemetry data is subsequently transmitted to the ML Processing Unit (102), which serves as the primary intelligence layer of the apparatus. The ML Processing Unit is configured to continuously analyze historical and real-time telemetry information to establish dynamic operational baselines representing expected system behavior under varying workload conditions. These baselines are continuously updated as system conditions evolve, thereby ensuring adaptive monitoring capabilities.

Unlike conventional monitoring systems that rely upon static threshold values, the ML Processing Unit (102) utilizes machine learning algorithms capable of understanding contextual relationships among multiple operational parameters. Such parameters may include processor utilization, memory consumption, network throughput, transaction latency, error rates, service response times, database performance metrics, and application availability indicators. Through multivariate analysis, the system can identify subtle deviations that may indicate emerging incidents before they become critical failures.

In one implementation, the ML Processing Unit employs supervised learning models trained on historical incident datasets to recognize known failure patterns. In another implementation, unsupervised learning algorithms such as clustering techniques, anomaly detection networks, and autoencoders are utilized to identify previously unseen operational abnormalities. The combination of supervised and unsupervised learning methodologies enables comprehensive detection of both known and unknown failure scenarios.

Upon detection of an anomaly, the ML Processing Unit generates one or more anomaly confidence scores indicating the probability that the observed deviation represents a genuine operational incident. These confidence scores may be weighted according to service criticality, business impact, workload characteristics, historical reliability metrics, and environmental conditions. The generated anomaly intelligence is then transmitted to the Topology-Aware Engine (103) for contextual evaluation.

The Topology-Aware Engine (103) maintains a continuously updated dependency graph representing relationships among applications, microservices, databases, virtual machines, containers, network devices, storage resources, and cloud infrastructure components. The dependency graph is generated through automated discovery procedures, telemetry analysis, orchestration platform integrations, and service communication monitoring. Such topology awareness provides the apparatus with a comprehensive understanding of how infrastructure components interact with one another.

The dependency graph maintained by the Topology-Aware Engine enables impact propagation analysis whenever anomalies are detected. For example, if an anomaly is identified within a database cluster, the engine can immediately determine which dependent applications, APIs, microservices, and customer-facing systems may be affected. This capability allows the apparatus to distinguish root causes from secondary symptoms and significantly improves incident prioritization accuracy.

The Diagnostic Module (104) receives anomaly intelligence from the ML Processing Unit (102) and dependency information from the Topology-Aware Engine (103). The Diagnostic Module performs automated root cause analysis by correlating telemetry patterns, dependency relationships, historical incidents, deployment activities, configuration changes, and infrastructure events. Through advanced correlation algorithms, the system isolates the most probable source of the detected operational disruption.

In various embodiments, the Diagnostic Module utilizes causal inference models, event correlation engines, probabilistic reasoning frameworks, and graph-based analytics to identify root causes with high confidence. The module may further generate diagnostic reports containing affected resources, incident severity levels, confidence scores, dependency relationships, estimated business impact, and recommended remediation actions. Such reports provide transparency and traceability throughout the incident management lifecycle.

Once a root cause has been identified, the Diagnostic Module (104) generates an incident resolution request and transmits the request to the Automated Remediation Controller (105). The incident resolution request may include detailed information regarding affected services, operational dependencies, anomaly characteristics, recommended corrective actions, and validation requirements necessary to restore system stability.

The Automated Remediation Controller (105) is configured to autonomously execute corrective actions based on predefined operational runbooks, policy frameworks, machine learning recommendations, or dynamically generated recovery procedures. Such corrective actions may include restarting services, redeploying application instances, scaling infrastructure resources, clearing resource bottlenecks, updating configurations, rerouting traffic flows, or initiating failover procedures.

In one embodiment, the Automated Remediation Controller may perform automated rollback operations whenever newly deployed software versions are determined to be the source of an incident. Such rollback operations may include restoration of previous application versions, redeployment of stable container images, reversal of configuration changes, database recovery operations, and restoration of infrastructure snapshots. These capabilities enable rapid recovery from deployment-related failures.

Prior to executing a remediation action, the Automated Remediation Controller may perform risk assessment procedures designed to evaluate potential operational consequences associated with the selected recovery strategy. Such assessments may consider service criticality, customer impact, infrastructure dependencies, security requirements, regulatory compliance obligations, and historical remediation outcomes. Based upon the assessment results, the system may either proceed autonomously or request administrator approval.

Following execution of remediation activities, the apparatus initiates post-remediation validation procedures to confirm successful incident resolution. Validation operations may include synthetic transaction testing, service health verification, performance monitoring, infrastructure integrity assessments, dependency validation checks, and application responsiveness measurements. The objective of these procedures is to ensure that operational stability has been fully restored.

If post-remediation validation confirms successful recovery, the incident is marked as resolved and the recovery details are recorded within the Feedback Loop Database (106). Conversely, if validation procedures indicate incomplete recovery or continued instability, the system may automatically initiate secondary remediation workflows, escalate the incident, or perform additional diagnostic analysis to identify alternative root causes.

The Feedback Loop Database (106) serves as a centralized repository for storing telemetry data, anomaly records, diagnostic conclusions, remediation decisions, validation outcomes, operational metrics, incident histories, and performance measurements. This continuously expanding knowledge base enables the apparatus to learn from previous operational experiences and improve future decision-making processes.

The Reinforcement Learning Module (128) accesses information stored within the Feedback Loop Database to continuously optimize anomaly detection models, root cause analysis algorithms, remediation strategies, and threshold evaluation parameters. By analyzing successful and unsuccessful remediation outcomes, the module learns which actions produce the most effective operational results under different environmental conditions.

Through continuous monitoring, intelligent anomaly detection, topology-aware impact assessment, automated root cause analysis, autonomous remediation execution, post-recovery validation, and reinforcement learning-based optimization, the disclosed apparatus establishes a fully autonomous incident isolation and recovery framework. The invention significantly reduces Mean Time to Detection (MTTD), Mean Time to Recovery (MTTR), operational overhead, and service downtime while simultaneously improving infrastructure resilience, application availability, and overall cloud operational efficiency.

The claimed invention is:

1. An apparatus for autonomous incident management in a distributed computing environment, comprising: a telemetry ingestion engine for normalizing multi-source data; an ML unit for establishing dynamic behavioral baselines and detecting anomalies; a topology-aware engine for mapping component interdependencies; a diagnostic module for root cause analysis (RCA); and an automated remediation controller.

2. The apparatus of claim 1, wherein the ingestion engine aggregates data from disparate sources including application performance monitoring tools, infrastructure logs, network devices, and orchestration platforms to create a cohesive operational view.

3. The apparatus of claim 1, wherein the ML unit employs unsupervised learning algorithms, such as autoencoder neural networks, to detect novel operational abnormalities that have no historical precedent.

4. The apparatus of claim 1, wherein the ML unit uses supervised learning models trained on historical incident datasets to recognize and classify known failure patterns with high precision.

5. The apparatus of claim 1, wherein the ML unit assigns multi-dimensional confidence scores to detected anomalies based on business impact, service criticality, and potential for systemic failure.

6. The apparatus of claim 1, wherein the topology-aware engine utilizes real-time discovery procedures to maintain an active dependency graph that represents the relationships between physical infrastructure, virtualized containers, and microservices.

7. The apparatus of claim 6, wherein the topology-aware engine determines an incident “blast radius” by tracing dependency chains between microservices and infrastructure components to identify the scope of failure.

8. The apparatus of claim 1, wherein the diagnostic module employs causal inference models and probabilistic reasoning to correlate seemingly disjointed anomalies across the dependency graph.

9. The apparatus of claim 1, wherein the remediation controller executes corrective actions including intelligent service restarts, traffic rerouting, resource scaling, or configuration rollbacks.

10. The apparatus of claim 9, wherein the remediation controller performs a pre-execution risk assessment to evaluate the potential operational consequences of a proposed recovery action before authorization.

11. The apparatus of claim 1, further comprising a post-remediation validation module that autonomously confirms service restoration via synthetic transaction testing and infrastructure health checks.

12. The apparatus of claim 1, further comprising a feedback loop database that records the entire incident lifecycle, including anomaly characteristics, diagnostic conclusions, and remediation outcomes.

13. The apparatus of claim 12, further comprising a reinforcement learning module that optimizes future diagnostic and remediation strategies by learning from the outcomes stored in the feedback loop database.

14. The apparatus of claim 1, wherein the system is configured to support automated escalation protocols, notifying human operators only when automated remediation attempts fail to resolve the incident.

15. A computer-implemented method for autonomous incident lifecycle management, comprising: ingesting heterogeneous telemetry data; detecting anomalies via ML models; mapping dynamic dependencies; isolating root causes; and executing automated recovery workflows.

16. The method of claim 15, wherein the ingestion step includes normalizing complex data from multiple monitoring vendors into a unified schema to enable cross-domain correlation.

17. The method of claim 15, wherein anomaly detection comprises a multivariate analysis of critical performance metrics including CPU utilization, memory consumption, latency, and throughput.

18. The method of claim 15, wherein isolating the root cause involves filtering symptomatic alerts and utilizing dependency mapping to reveal the singular underlying failure trigger.

19. A non-transitory computer-readable medium storing instructions that, when executed, cause a processor to perform: telemetry aggregation; real-time anomaly detection;
dependency-aware impact propagation analysis; and automated remediation execution.

20. The medium of claim 19, wherein the instructions further cause the processor to perform continuous model refinement by retraining ML algorithms based on the forensic logs of previous incident resolutions
